(19) United States
(12) Patent Application Publication
(10) Pub. No.: US 2018/0059660 A1
(43) Pub. Date: Mar. 1, 2018

(54) INTELLIGENT EVENT RESPONSE WITH UNMANNED AERIAL SYSTEM

(71) Applicant: Group Care Technologies, LLC, Boca Raton, FL (US)

(72) Inventors: Eric Heatzig, Boca Raton, FL (US); Gathan Broadus, Boca Raton, FL (US); Russell Orzel, Boca Raton, FL (US)

(21) Appl. No.: 15/684,549

(22) Filed: Aug. 23, 2017

Related U.S. Application Data
(60) Provisional application No. 62/378,428, filed on Aug. 23, 2016.
(60) Provisional application No. 62/380,613, filed on Aug. 29, 2016.

(51) Int. Cl. G05D 1/00; B64C 39/02; H04N 5/38; G06K 9/00

(52) U.S. Cl. CPC G05D 1/0038; B64C 39/024; H04N 5/38; G06K 9/00664; B64C 25/32; B64C 2201/027; B64C 2201/127; B64C 2201/141; B64C 2201/146; B64C 2201/108

(57) ABSTRACT

A system for remotely displaying video captured by an unmanned aerial system (UAS), the system comprising an unmanned aerial system (UAS) including an unmanned aerial vehicle (UAV), one or more image capture devices coupled to the UAV for capturing video of an environment surrounding the UAV, and an onboard transmitter for transmitting a short-range or medium-range wireless signal carrying the video of the environment surrounding the UAV; a portable communications system including a receiver for receiving the short-range or medium-range wireless signal transmitted from the UAS and a transmitter for transmitting a long-range wireless signal carrying the video of the environment surrounding the UAV to a wide area network (WAN); and a server in communication with the WAN, the server being configured to share the video of the environment surrounding the UAV with one or more remote devices for display on the one or more remote devices.

### RELATED U.S. APPLICATIONS

This application claims priority to U.S. Provisional Patent Application Ser. No. 62/378,428, filed Aug. 23, 2016, and to U.S. Provisional Patent Application Ser. No. 62/380,613, filed Aug. 29, 2016, each of which is hereby incorporated herein by reference in its entirety for all purposes.

### BACKGROUND

Law enforcement, paramedics, search and rescue, and other public safety personnel often suffer from a significant lack of situational awareness when responding to emergency situations. For example, responders may be unfamiliar with the event environment (e.g., layout of a building), as well as with the locations and movements of persons (e.g., suspects, hostages, bystanders, other responders) and objects (e.g., ditched evidence, explosive devices, fire) associated with the event, thereby making it more difficult to quickly, effectively, and safely coordinate and execute a response to the event.

Camera-equipped robots are sometimes deployed ahead of responders to capture imagery of the event environment in particularly dangerous situations. While such an approach can help to mitigate risk to responders, existing robots are often costly, fragile, and difficult or impossible to transport and rapidly deploy on-scene. Further, many such robots are unable to quickly and effectively navigate stairs or other difficult terrain. As such, responders may opt not use these robots except in the most dangerous of situations, and even then their effectiveness can be quite limited due to these and other drawbacks. Still further, many existing robots are only capable of transmitting captured imagery to the operator of the robot and not to other responders, including command and control personnel attempting to direct a coordinated response.

Even when information is available, it often does not reach (or is significantly delayed in reaching) those particular responders who need it most. Further, the information may come from multiple sources in multiple formats, making it difficult to integrate relevant information into a common operating picture that that responders can quickly understand and act upon.

### SUMMARY OF THE INVENTION

The present disclosure is directed to a system for remotely displaying video captured by an unmanned aerial system (UAS). The system may generally comprise an unmanned aerial system (UAS), a portable communications system, and a server. The UAS may include an unmanned aerial vehicle (UAV), one or more image capture devices coupled to the UAV for capturing video of an environment surrounding the UAV, and an onboard transmitter for transmitting a short-range or medium-range wireless signal carrying the video of the environment surrounding the UAV. The portable communications system may include a receiver for receiving the short-range or medium-range wireless signal transmitted from the UAS and a transmitter for transmitting a long-range wireless signal carrying the video of the environment surrounding the UAV to a wide area network (WAN). The server may be in communication with the WAN, and may be configured to share the video of the environment surrounding the UAV with one or more remote devices for display on the one or more remote devices.

The video of the environment surrounding the UAV, in various embodiments, may be shared with the one or more remote devices in real-time or near real-time. In some embodiments, the onboard transmitter and the receiver may be Wi-Fi radios and the short-range or medium-range wireless signal may be a Wi-Fi signal. In some embodiments, the transmitter may be one of a cellular transmitter or a satellite transmitter, and the long-range wireless signal may be one of a cellular signal or a satellite signal, respectively.

The portable communications system, in various embodiments, may further include a controller for remotely piloting the UAV and display for displaying the video of the environment surrounding the UAV. The onboard transmitter, in some embodiments, may be configured to transmit a second short-range or medium-range wireless signal carrying the video of the environment surrounding the UAV for display on one or more wearable devices situated proximate the UAS. The one or more remote devices, in an embodiment, may be configured to receive and display the video of the environment surrounding the UAV via an internet browser or mobile application.

The UAS, in various embodiments, may be further configured to transmit, to the server via the short-range or medium-range wireless signal and the long-range wireless signal, information concerning at least one of a location, an attitude, and a velocity of the UAV. The server may be configured to associate the information concerning at least one of the location, the attitude, and the velocity of the UAV with coordinates and scale of a corresponding map for sharing with the one or more remote devices A browser or mobile application running on the one or more remote devices may be configured to display a map showing the corresponding location, attitude, and velocity of the UAS. The server, in some embodiments, may be further configured to associate information concerning a location of one or more persons or objects with the coordinates and scale of the map for sharing with the one or more remote devices, and the browser or mobile application running on the one or more remote devices may be configured to display the corresponding locations of the one or more persons or objects on the map.

The UAS, in various embodiments, may be further configured to transmit, to the server via the short-range or medium-range wireless signal and the long-range wireless signal, information concerning at least one of a location, an attitude, and a velocity of the UAV. The server may be configured to identify reference structure in the video of the environment surrounding the UAV and associate the reference structure with the information concerning at least one of the location, the attitude, and the velocity of the UAV to generate a Simultaneous Localization and Mapping (SLAM) map of the corresponding environment surrounding the UAV.

The server, in various embodiments, may be further configured to process the video of the environment surrounding the UAV to identify persons or objects present in the video, and retrieve information associated with the identified persons or objects from one or more databases for sharing and display on the one or more remote devices.

In another aspect, the present disclosure is directed to an unmanned aerial system (UAS). The UAS may generally comprise an unmanned aerial vehicle (UAV), one or more image capture devices coupled to the UAV for capturing video of an environment surrounding the UAV, and a transmitter for transmitting a wireless signal carrying the video of the environment surrounding the UAV. The UAV may comprise a substantially rectangular and flat airframe, four rotors situated in-plane with the airframe, the four rotors being positioned proximate each of four corners of the substantially rectangular and flat airframe, and first and second handholds integrated into opposing peripheries of the airframe and situated along a pitch axis of the UAV between those two of the four rotors positioned adjacent to each of the first and second handholds along the corresponding periphery of the airframe.

The airframe, in various embodiments, may have a height dimension substantially equal to a height of the four rotors situated in-plane with the airframe, and may forms circular ducts about each of the four rotors. Each of the first and second handholds, in various embodiments, may include a hollow cutout extending through the airframe near an outer edge of the corresponding periphery.

The UAS, in various embodiments, may further comprise one or a combination of a flexible skirt for assisting an operator in stabilizing the image capture device against a window to reduce glare, one or more magnets configured to magnetically engage a metallic surface for stabilizing the UAV in place proximate the surface, and a glass break mechanism.

The UAS, in various embodiments, may further comprise a vision-based control system for automatically adjusting one or more flight controls to stabilize the UAV in hover. Thee control system may comprise a controller configured to identify one or more landmarks present in the video of the environment surrounding the UAV; evaluate a size and location of the one or more landmarks in the video at a first point in time; evaluate a size and location of the one or more landmarks in the video at a second, subsequent point in time; compare the size and location of the one or more landmarks at the first point in time with the size and location of the one or more landmarks at a second point in time to determine whether and by how much the size and location of the one or more landmarks has changed; estimate, based on the change in the size and location of the one or more landmarks, a corresponding change in a location, altitude, or attitude of the UAS from a desired hover pose; automatically adjust one or more flight controls to compensate for the corresponding change in the location, altitude, or attitude of the UAS; and continue performing the preceding steps until a size and location of the one or more landmarks substantially matches the size and location of the one or more landmarks at the first point in time. In an embodiment, the controller may be configured to compare the estimated change in location, altitude, or attitude of the UAS from a desired hover pose with telemetry data collected by one or more inertial sensors of the UAV.

### BRIEF DESCRIPTION OF DRAWINGS

For a more complete understanding of this disclosure, reference is now made to the following description, taken in conjunction with the accompanying drawings, in which:

FIG. 1 illustrates a representative embodiment of an event response system in accordance with one embodiment of the present disclosure;

FIG. 2 illustrates communications links for transmitting video and other information from a UAS to wearable devices, in accordance with one embodiment of the present disclosure;

FIG. 3 illustrates communications links for transmitting video and other information from a UAS to a portable communications system, an event response server, and remote devices, in accordance with one embodiment of the present disclosure;

FIG. 4A, FIG. 4B, and FIG. 4C illustrate a representative embodiment of a UAS, in accordance with one embodiment of the present disclosure;

FIG. 5A illustrates a bumper for dampening impact forces, in accordance with one embodiment of the present disclosure;

FIG. 5B illustrates an operator holding a UAS by a handhold, in accordance with one embodiment of the present disclosure;

FIG. 6A, FIG. 6B, and FIG. 6C illustrate a representative embodiment of a portable communications system of an event response system, in accordance with one embodiment of the present disclosure;

FIG. 7 illustrates a representative hardware architecture of a portable communications system of an event response system, in accordance with one embodiment of the present disclosure;

FIG. 8A, FIG. 8B, and FIG. 8C illustrate a representative embodiment of a wearable device of an event response system, in accordance with one embodiment of the present disclosure;

FIG. 9A and FIG. 9B illustrate a representative embodiment of a remote device of an event response system, in accordance with one embodiment of the present disclosure;

FIG. 10 illustrates a representative embodiment of an event response server of an event response system, in accordance with one embodiment of the present disclosure;

FIG. 11 illustrates a workflow for routing information through an event response system based on a priority of the event, in accordance with one embodiment of the present disclosure;

FIG. 12 assigning roles to users and user devices of an event response system, in accordance with one embodiment of the present disclosure; and

FIG. 13A and FIG. 13B illustrate a front-end interface between responders and an event response server, in accordance with one embodiment of the present disclosure.

### DESCRIPTION OF SPECIFIC EMBODIMENTS

Embodiments of the present disclosure generally provide a system for remotely displaying video captured by an unmanned aerial system (UAS) for enhancing situational awareness of persons responding to an event. In particular, and as further described throughout the present disclosure, the systems may help in obtaining and distributing information about the event and ongoing response efforts to help coordinate responders in rapidly planning and executing an effective and safe response to an ongoing event.

As used in the present disclosure, the term event is intended to broadly encompass any number of situations relating to public safety requiring involvement by agencies or authorities (e.g., law enforcement, national security, bomb disposal, emergency medical services). Illustrative examples of such events include, without limitation, hostage situations, police standoffs, bank robberies, bomb threats, terror attacks, structure fires, building collapse, natural disasters, suspicious packages or objects, and the like.

A response, as used in the present disclosure, is intended to broadly encompass actions taken by one or more persons to monitor, assess, intervene, or otherwise engage in activity associated with understanding or resolving issues related to the event. While not intended to be limited as such, systems of the present disclosure may be described in the context of streaming video and other information collected by a UAS to various responders (including command and control personnel located remotely from the event), as well as generating processed intelligence such as interactive maps of the event environment for enhancing situational awareness.

Notwithstanding the illustrative examples described above, one of ordinary skill in the art will recognize any number of situations within the scope of the present disclosure that may be understood as events to which the systems described herein may be used in enhancing situational awareness and facilitating coordination of an effective and safe response to the event.

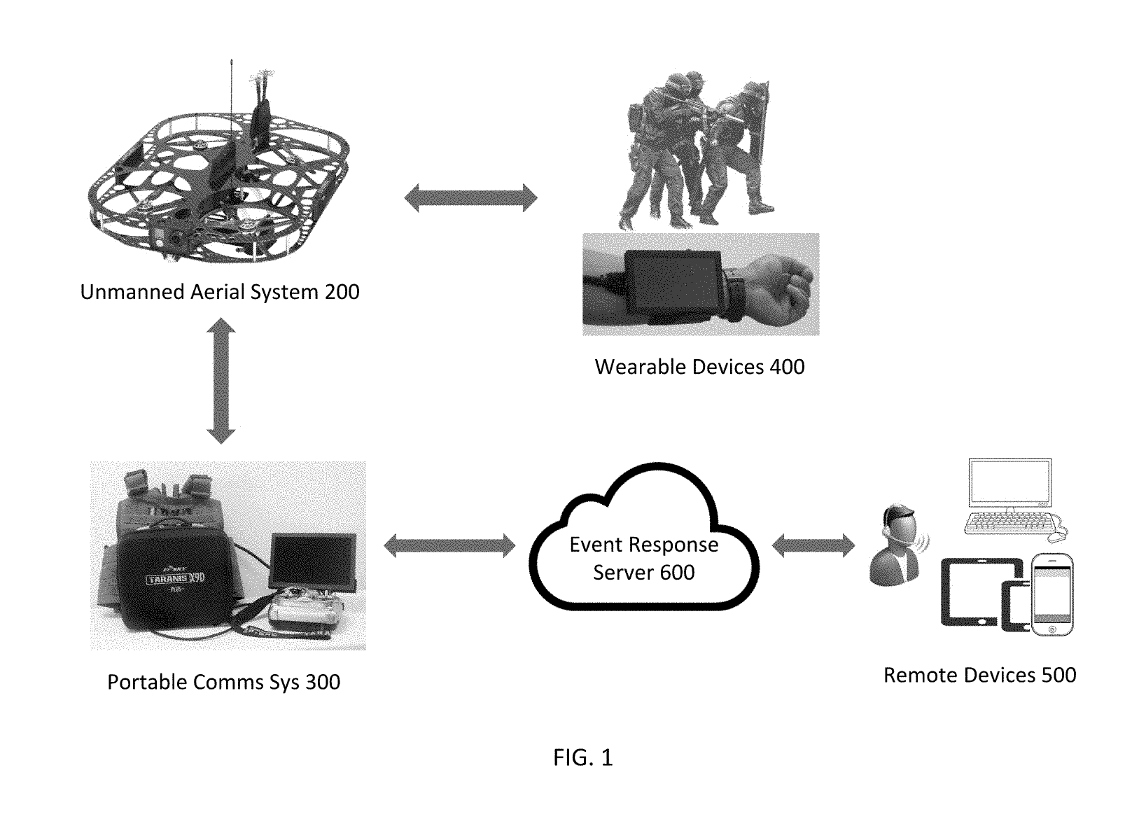

FIG. 1 illustrates a representative embodiment of event response system 100 of the present disclosure. Event response system 100, in various embodiments, may generally include one or a combination of an unmanned aerial system 200, a portable communications system 300, one or more wearable devices 400, one or more remote devices 500, and an event response server 600, as later described in more detail.

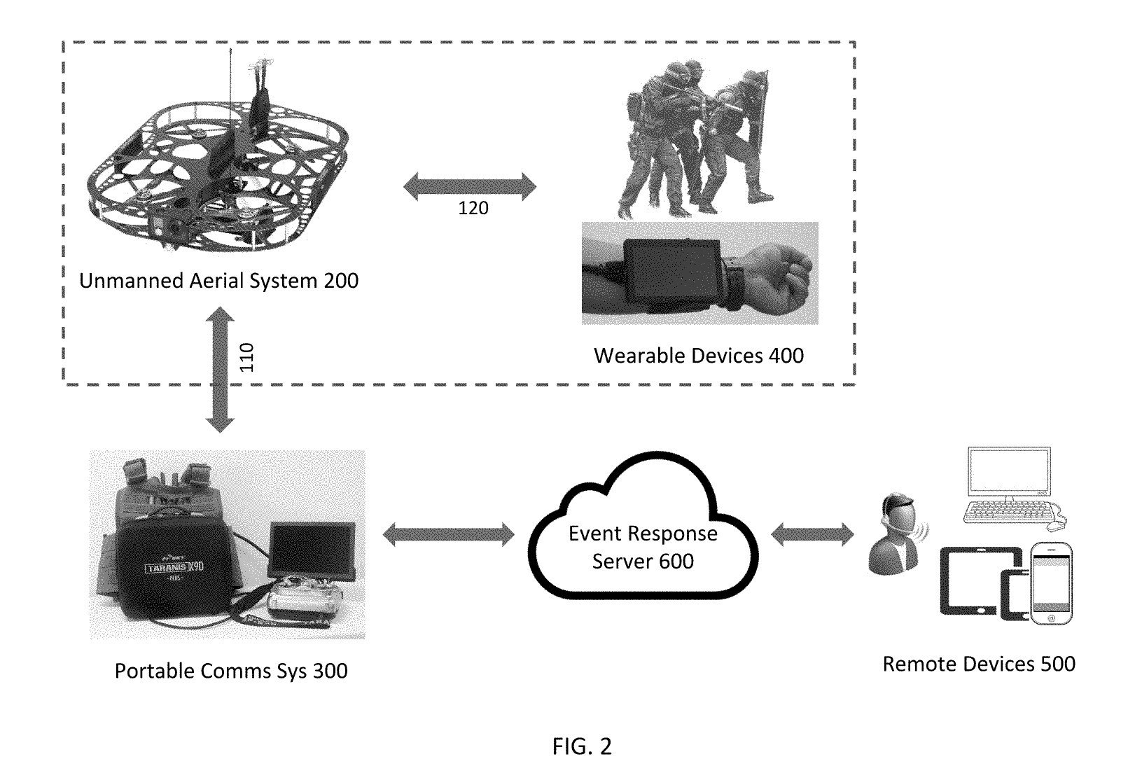

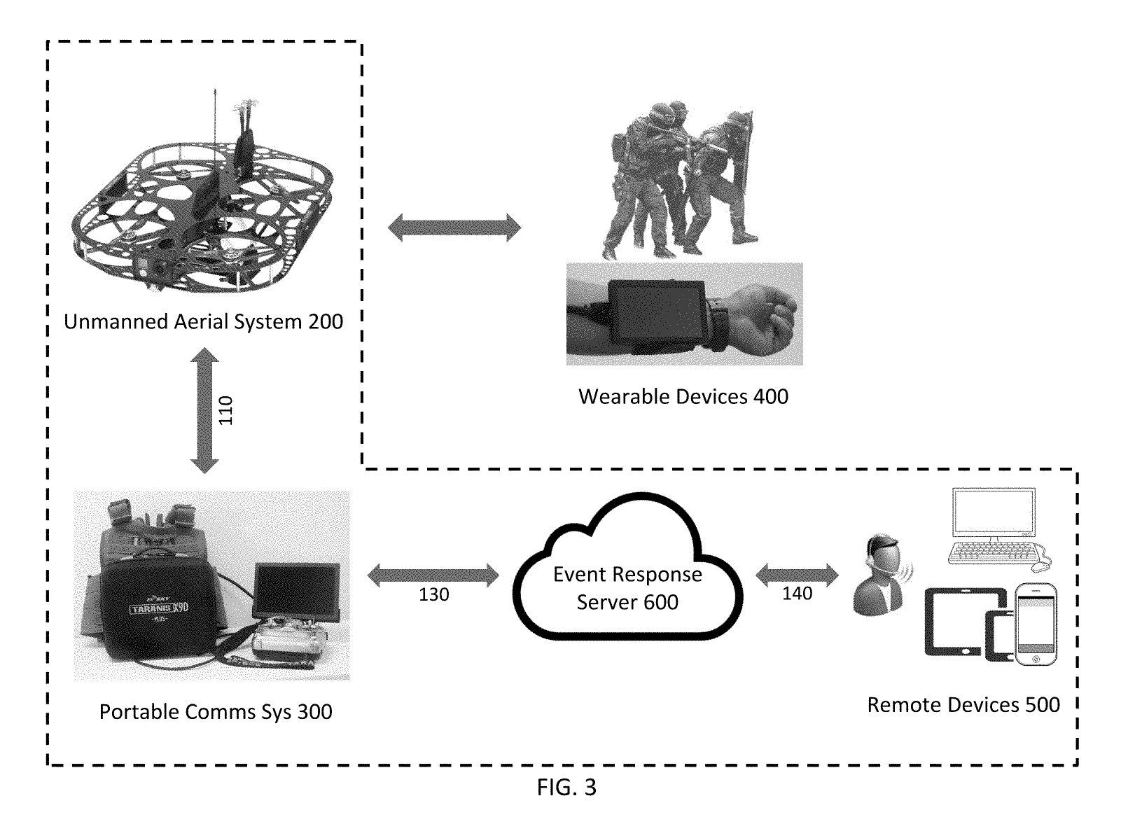

Event response system 100 may be configured for enhancing situational awareness of persons responding to an event. In particular, UAS 200 may be flown on-scene by an operator using portable communications system 300 to collect video and other information about the event and any ongoing response to the event. This video and other information may be transmitted in real-time (or near real-time) to devices operated by one or a combination of local responders and remote responders via one or more communications links. For example, as shown in FIG. 2, the video and other information may be transmitted to devices 400 (e.g., wrist-mounted display) operated by local responders (e.g., on-scene law enforcement officers) via communications link 110 connecting UAS 200 to portable communications system 300 and communications link 120 connecting UAS 200 to wearable device(s) 400. As another example, as shown in FIG. 3, the information may additionally or alternatively transmitted to remote devices 500 operated by remote responders (e.g., central command personnel) via communications link 110 (connecting UAS 200 to portable communications system 300), communications link 130 (connecting portable communications system 300 to event response server 600), and communications link 140 (connecting event response server 600 to remote device(s) 500).

In some embodiments, the video and other information may be provided to responders in substantially unprocessed form (e.g., direct video feed, telemetry), while in other embodiments, the video and other information may be processed by event response server 600 to generate other forms of intelligence, as later described in more detail. For example, in an embodiment, event response server 600 may process video and other information collected by UAS 200, perhaps along with information from other sources (e.g., locator beacons, satellite imagery, building blueprints), to generate maps of the event environment for display to responders on remote devices 500, thereby aiding responders in more effectively planning and executing a response to the event. In addition to transmitting processed intelligence information to remote devices 500 operated by remote responders (as shown), event response server 600 may additionally or alternatively transmit the processed intelligence information to wearable devices 400 for display to local responders, thereby further enhancing situational awareness of both on-scene and remote responders alike. For example, in one such embodiment, the processed intelligence may be transmitted to wearable devices 400 via communications link 130 connecting event response server 600 and portable communications system 300, and communications link 120 connecting portable communications system 300 to wearable device(s) 400.

Communications links 110, 120, 130, 140, in various embodiments, are wireless using signals and protocols generally understood in the telecommunications art. For example, communications link 110, which connects UAS 200 and portable communications system 300, may be established via short- or medium-range wireless signals suitable for transmitting flight control commands and information gathered by UAS 200. In various embodiments, communications link 110 may comprise two separate links—one link 112 for transmitting flight controls to UAS 200, and another link 114 for transmitting video and other information collected by UAS 200 back to portable communications system 300 (not shown). In an embodiment, flight controls may be transmitted via link 112 comprising standard radio signals, while video and other information collected by UAS 200 may be transmitted via link 114 comprising higher-bandwidth signals, such as Wi-Fi. Communications link 120, which connects UAS 200 and device(s) 400, may be established via short- or medium-range wireless signals suitable for transmitting the video and other information collected by UAS 200 for display on device(s) 400, such as Wi-Fi. In various embodiments, communications links 110 and 120 may be designed to provide high-definition video with maximum signal range with buildings such that the signals can penetrate internal walls to reach portable communications system 300 and wearable devices 400 when necessary. Communications link 130, which connects portable communications system 300 and event response server 600, may be established via long-range wireless signals suitable for transmitting the video and other information collected by UAS 200 for display on wearable device(s) 400, such as cellular. In particular, portable communications system 300 may transmit the information via cellular signal to a cellular tower, where it is then routed to event response server via wired or wireless wide area network (WAN) infrastructure (e.g., broadband cable, Ethernet, fiber). Communications link 140, which connects event response server 600 and remote device(s) 500, may be established via wired or wireless WAN infrastructure or other long-range wireless signals suitable for transmitting the video and processed intelligence information for display on remote device(s) 500, depending on the type of remote device 500 being used. For example, wired connection (e.g., broadband cable, Ethernet, fiber) may be suitable for connecting to a fixed remote device 500, such as a computer located at a central station like a real-time crime center (RTCC), whereas a wireless connection (e.g., cellular or satellite) may be more appropriate for connecting to a portable remote device 500, such as portable deployment package 610, later described in more detail. In various embodiments, some or all of the aforementioned communications links may be encrypted and optimized for near-zero latency.

### UAS 200

UAS 200 of event response system 100 may comprise any commercially available or custom-built unmanned aerial vehicle (UAV) and payload (collectively, unmanned aerial system) suitable for collecting and transmitting information in accordance with present disclosure. Generally speaking, the type of UAV used (along with its size, endurance, and flight stability amongst other relevant criteria) may depend on the circumstances of the event and/or operating environment. For example, for events in which UAS 200 may be operated indoors or in other space-constrained environments, it may be desirable to select a UAV having capabilities well-suited for rapid launch, precise control, and high stability, such as a multirotor UAV with vertical take-off and landing (VTOL) and hover capabilities. Conversely, for events in which UAS 200 needs to loiter for long periods of time in relatively unobstructed outdoor environments, it may be desirable to select a UAV having a fixed-wing, tilt-wing, or tilt-rotor design well-suited for maximizing loiter efficiency at airspeeds suited to the particular mission. Similarly, the types payloads may vary depending on the particular event and types of information to be collected. Representative payloads may include audio/visual equipment such as image capture devices (e.g., image sensors or cameras with traditional, infrared, and/or thermal imaging capabilities), image stabilizers, microphones, and speakers, as well as communications and navigation equipment as later described in more detail. One or ordinary skill in the art will recognize suitable configurations of UAS 200 depending on the circumstances of the particular event and surrounding environment.

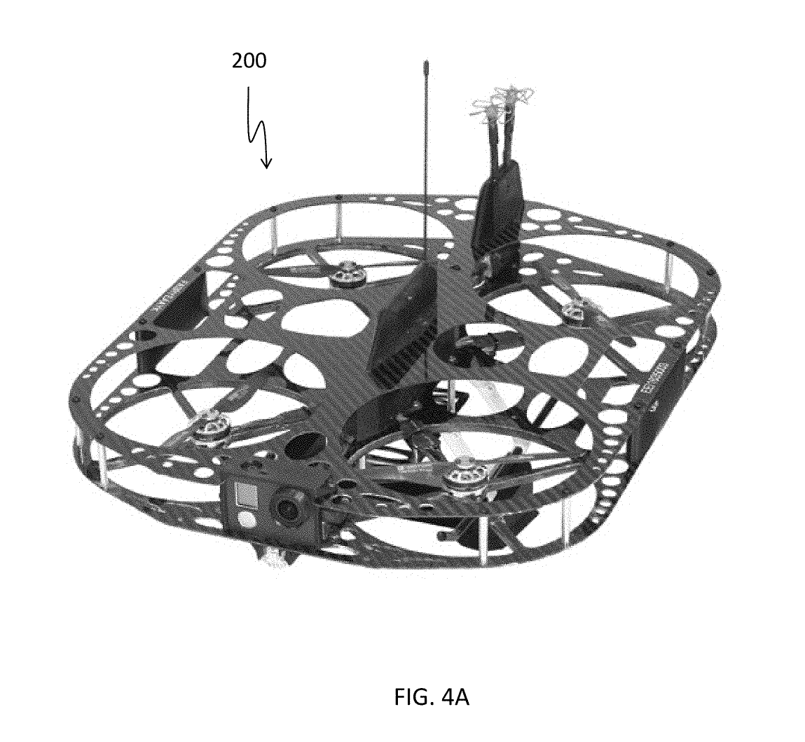

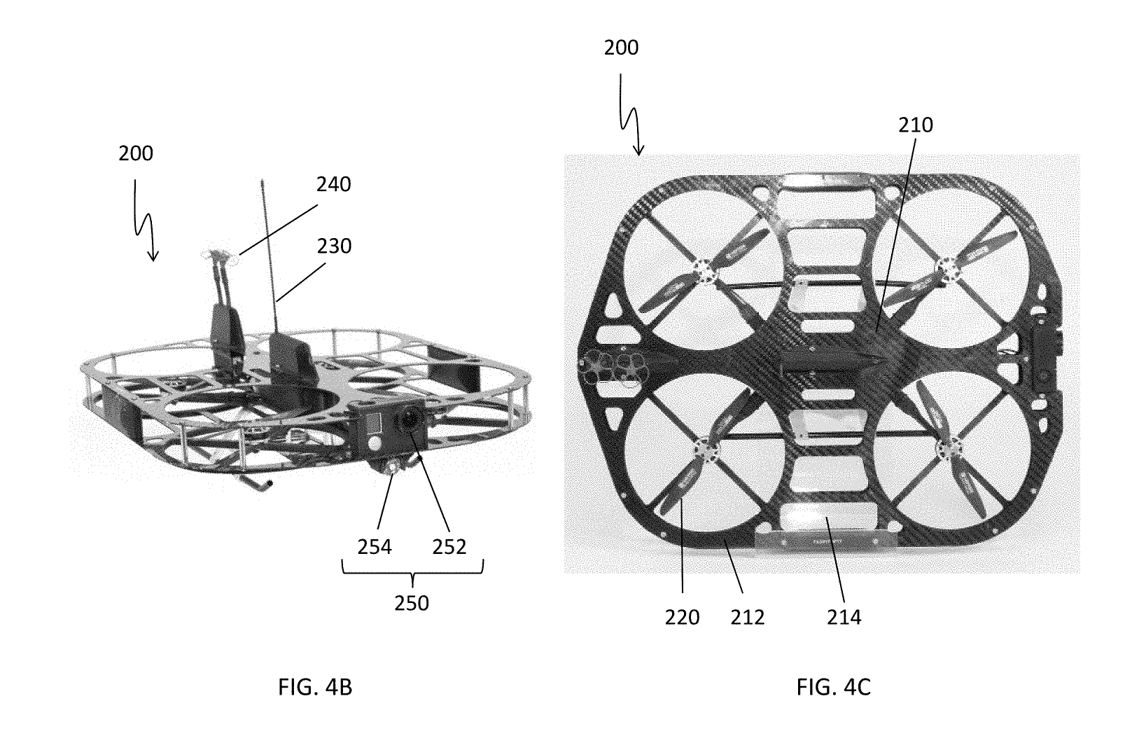

FIGS. 4A-4C illustrate a representative embodiment of UAS 200 particularly well-suited for operation in confined environments, such as indoors or proximate to obstructions. As shown, this embodiment of UAS 200 may comprise a quadrotor design comprising airframe 210, rotors 220, controls receiver 230, onboard transmitter 240, and imaging system 250.

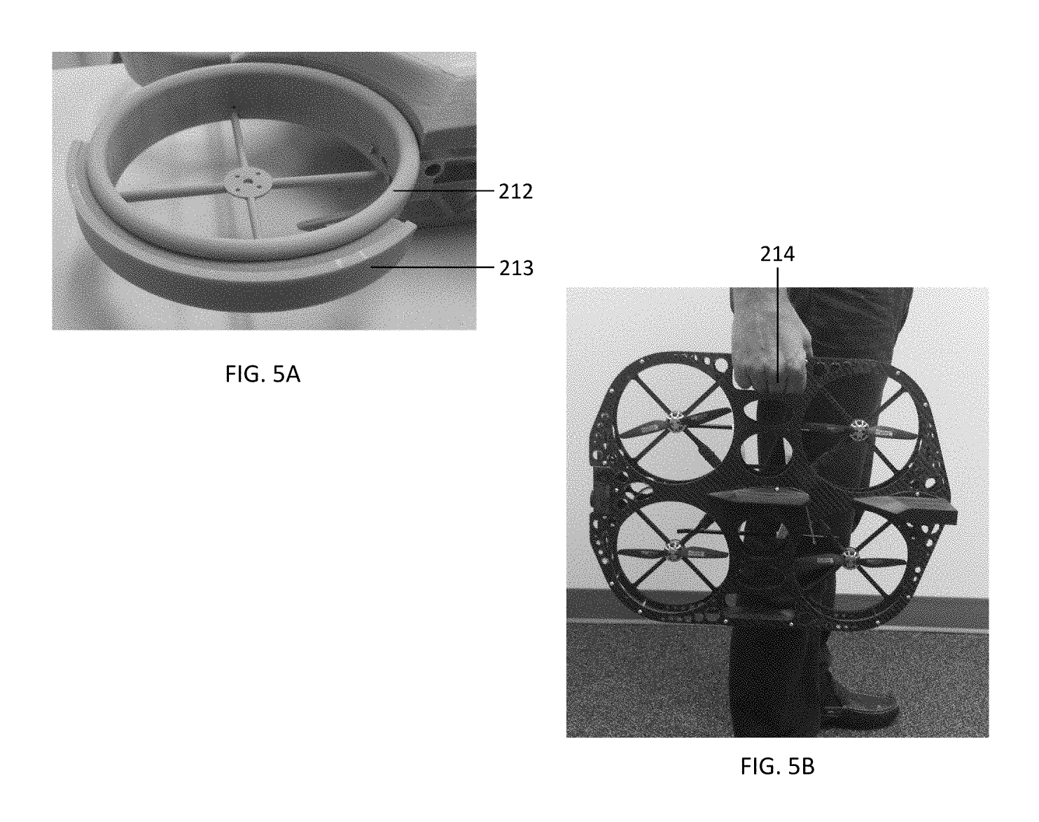

Airframe 210 has a substantially rectangular planform when viewed from above (FIG. 4C) and relatively flat profile when viewed from the front (FIG. 4B). The relatively flat profile refers to height dimension of airframe 210 (taken along a yaw axis) which, as shown, is substantially equal to a height dimension of rotors 220. Airframe 210 further includes four circular ducts 212 for housing rotors 220 in-plane with airframe 210, each positioned proximate each of the four corners of the substantially rectangular planform of airframe 210. Referring ahead to FIG. 5A, outer surfaces of ducts 212 can be provided with bumpers to dampen forces should UAS 200 be dropped during transport or hit a wall during flight. Airframe 210 is primarily constructed of a composite material such as carbon fiber. These features combine to provide a very compact, lightweight, and rugged airframe capable of protecting key components from damage from impacts incurred during transport and flight.

Airframe 210 further includes handholds 214 integrated into the port and starboard peripheries of airframe 210. Handholds 214, in various embodiments, are hollow cutouts extending vertically through airframe 210 near an outer edge of the corresponding periphery and dimensioned to receive the operators fingers in a grip much like one may grip the handle of a briefcase. Each handhold 214 is situated along the pitch axis between those two of the four rotors 220 positioned adjacent to a given one of the handholds 214. Stated otherwise, the port handhold 214 is positioned between the fore and aft rotors 220 on the port side, and the starboard handhold 214 is positioned between the fore and aft rotors 220 on the starboard side, as shown. Grip inserts in handholds 214 can be tailored in terms of material and design to the user's needs. For example, handhold 214 can be provided a smaller grip to create more space in handhold 214 for accommodating gloved hands.

The locations of handholds 214 provide both a convenient and safe way of carrying and deploying UAS 200 when it is armed as well as unarmed. This is a particularly beneficial feature, as most UAVs on the market are awkward to carry and often require the user to place his fingers near unguarded propellers. Referring ahead to FIG. 5B, handholds 214 further allow the operator to carry UAS 200 with one hand, thereby freeing up the operator's other hand for other tasks. This is particularly important for law enforcement personnel who must keep their other hand free for other activities such as holding a pistol or flashlight, or signaling other officers. As configured, UAS 200 may be held tight to the body and carried like a briefcase, allowing the operator to walk or run with greater ease and thus faster and longer if necessary, and to remain tight to walls and other responders. The flat pack design of the airframe, with rotors 220 set within and protected by ducts 212, minimizes the risk of inadvertent propeller damage during transport, thereby freeing up the operator to focus on the mission at hand in potential dangerous environments. Still further, handholds 214 can also be used as attachment points for a sling or strap that can allow the UAS 200 to be carried on the operator's body, possibly on his back or on a backpack or other equipment he may be already carrying.

In addition to protecting rotors 220, ducts 212 of the present embodiment may improve the aerodynamic efficiency of the rotors. First, the inlet ring or upper section of ducts 212 guides air smoothly into rotors 220. The upper inlet ring radius is greater than the radius of the rotors 220, which forms a venturi effect. This venturi effect lowers the pressure of the air surrounding the inlet ring. This low pressure area increases the effective area of the rotors 220, and increases the overall lift production. Secondly, rotors in hovering craft produce lift by creating a pressure differential. The airfoil shape of the rotors, combined with its pitch and rotation, create a low pressure area above the rotor and a high pressure area below the rotor. This pressure differential is both created by and separated by the rotor itself. The problem with this occurs at the rotor tip. Air just beyond the rotor tip no longer has a barrier separating the high pressure from the low pressure. The result is that the high pressure from under the rotor spills over to the top of the rotor. This creates both a recirculation of air, which reduces the effectiveness of the rotor at the tip, and also creates an aerodynamic phenomenon known as a tip vortices. Rotor tip vortices can be thought of as a small tornado following the tip of the rotor blade throughout its rotation. The result of these vortices is drag. Drag at the tip of the rotor means that the motor has to work harder to rotate the rotor, which robs the entire propulsion system of efficiency. Ducts 212 of the present disclosure require the tips of rotors 220 to rotate as close to ducts 212 as physically possible. The vertical wall of duct 212 at the tip of the rotor 2210 eliminates tip vortices and greatly reduces recirculation, which adds to overall efficiency. Finally, the exhaust end of duct 212 diverges exiting column of air slightly, which increases the static thrust, also increasing efficiency.

Ducts 212 can basically be thought of as having three aerodynamic sections: the inlet lip, vertical section, and divergent section. In our design, the final inlet lip radius of duct 212 was a compromise between an optimally sized duct, and our physical size limitations. The result was an inlet lip radius of 12 mm. The remaining proportions of the outside of the duct 212 are aerodynamically irrelevant in this application, and as such were kept to a minimal for weight considerations. The upper vertical portion of the inside of the duct 212 coincides with the bottom of the inlet lip radius, and the upper surface of the rotor 220. The length of the vertical portion of the duct 212 coincides with the thickness of the rotor 220, and in our design this was 12.27 mm. The divergent section of the duct 212 coincides with the lower portion of the vertical section, and the lower surface of the rotor 220. In our case, the bottom of the divergent section also contains the motor mount, so the length of the divergent section was such that the bottom surface of the rotor 220 met the lower side of the vertical section of the duct 212. The divergent angle of the duct is 10 degrees.

The diameter of ducts 212 was determined by the diameter of the selected rotors 220. The manufacturing tolerances of the commercially available rotors 220 and the tolerances of the 3D printer used for prototype construction were taken into account and a 0.5 mm gap between rotor 220 and duct 212 wall as targeted.

Referring to FIG. 4B, control receiver 230 is configured to receive flight control signals transmitted by portable communications system 300 along communications link 110 (and in particular, link 112). Control receiver 230 may be any commercially available receiver suitable for this intended purpose. In particular, control receiver 230 may include an antenna for receiving flight control signals (e.g., pitch, roll, yaw, throttle) from portable communications system, and relays them on to a processor responsible for implementing flight controls according to known methods.

Still referring to FIG. 4B, onboard transmitter 240 may be configured to transmit video and other information collected by UAS 200 to portable communications system 300 along communications link 110 and to wearable device(s) 400 along communications link 120. Onboard transmitter 240 may be any commercially available transmitter suitable for this intended purpose. In various embodiments, onboard transmitter 240 may be configured to transmit signals containing video and/or audio captured by image capture device(s) 252 and microphones. In various embodiments, onboard transmitter UAS 200 may additionally or alternatively transmit geospatial information about UAS 200, such as a location, attitude, and velocity of UAS 200. This information can be measured by navigational instruments onboard UAS 200 or any other suitable source. In various embodiments, onboard transmitter 240 of UAS 200 may additionally or alternatively transmit other information captured, measured, or otherwise obtained by various payloads of UAS 200.

For example, onboard transmitter 240 may, in one aspect, stream video captured by an image sensor or camera of UAS 200 to portable communications system 300 for display to the operator. This video stream may help the operator pilot UAS 200, especially in non-line-of-sight (NLOS) flight conditions. In another aspect, video and other information collected by UAS 200 and streamed by onboard transmitter 240 may provide the operator with enhanced situational awareness. For example, the operator may navigate UAS 200 into a room and view real-time (or near-real time) video of any threats on a the display of portable communications system 300 prior to entering. Should the operator identify a threat, he or she may be able to assess the nature of the threat via the transmitted information, thereby allowing the operator to warn team members in advance and potentially instruct them how to safely neutralize the threat. In yet another aspect, as previously described in the context of FIG. 2 and FIG. 3, UAS 200 may transmit the video and other information directly to wearable device(s) 400 and portable communications system 300 may transmit the video and other information received from UAS 200 to event response server 600 via communications links 120 and 130, respectively. In still another embodiment, system 100 may be configured such that the video and other information collected by UAS 200 is routed to wearable device(s) 400 via portable communications system 300 rather than directly transmitted thereto.

### UAS Payloads

Still referring to FIG. 4B, imaging system 250 may comprise equipment for capturing photos and/or video via UAS 200. In particular, in the present embodiment, imaging system 250 may include an image capture device 252 (e.g., image sensor, camera, or the like) and an illumination source 254, such as a powerful (e.g., 1000-2000 lumen) LED light or infrared light transmitter, for illuminating the field of view of image capture device 252. Imaging system 250 may be any commercially available system suitable for this intended purpose. Imaging system 250 may be remotely controlled via signals from portable communications system 300, allowing the operator to selectively turn imaging system on/off and to adjust features such as optical or digital zoom, image type (e.g., video, photo), illumination type (e.g., visible light, infrared), and illumination mode (e.g., soft, bright, strobe).

UAS 200, in various embodiments, may further comprise additional payloads for facilitating the collection of information about the event and response thereto. For example, UAS 200 may be equipped with payloads that facilitate the collection of information through windows, especially those obscured by glare or tinting. One method of overcoming glare is to position image capture device 252 against the window such that image capture device 252 blocks glare-inducing light from reaching the contacted portion of the window, thereby allowing image capture device 252 a clear view through the window. Piloting UAS 200 to position—and hold—image capture device 252 in such a manner can be tricky though, especially in outdoor environments where wind is a factor. To that end, in an embodiment, UAS 200 can be outfitted with a payload for assisting the operator in piloting UAS 200 to make and hold this image capture device-window contact. In one such embodiment, a flexible skirt (not shown) can be coupled to a front end of UAS 200 such that, in a neutral state, a distal end of the skirt extends beyond a distal end of image capture device 252. The operator may initially pilot UAS 200 to a position in front of the window, and then slowly advance UAS 200 until the flexible skirt contacts the window. Contact between the flexible skirt and the window helps initially stabilize UAS 200 in position in front of the window. The operator may then apply sufficient forward thrust to cause the flexible skirt to compress against the window until the image capture device 252 contacts the window. Continued forward thrust, necessary to maintain the flexible skirt in a compressed state, further helps to stabilize UAS 200 (and thus image capture device 252) in place against the glass. Without wishing to be bound by theory, in one aspect, the continued forward thrust creates a larger normal force between the flexible skirt and the window, thereby increasing friction at that juncture. Increased friction may counteract any perturberances (e.g., a cross wind, downdraft or updraft, or variations in thrust produced by one or more of the rotors) that may otherwise cause UAS 200 to drift side-to-side or up-and-down. In another aspect, should any perturberances cause the UAS 200 to pivot on its front end against the window during the maneuver (i.e., change attitude from substantially perpendicular to the window to slightly angled), the forward thrust continuously applied by the operator for maintaining the compressed skirt in a compressed state will oppose the perturbance and cause UAS 200 to pivot back into an attitude that is substantially perpendicular to the window. Stated otherwise, flexible skirt allows forward thrust to be applied continuously throughout the maneuver which, in turn, stabilizes the attitude of UAS 200 to point substantially perpendicular to the window, thereby allowing image capture device 252 to maintain flush contact against the surface of the window. In another embodiment, UAS 200 may be equipped with one or more magnets to help hold UAS 200 in place against a magnetic surface proximate to the window. For example, magnets may be attracted to the metallic side panel below a car window or to the metallic roof above the car window. Were magnets to be positioned near a front end of UAS 200 at a suitable distance below or above image capture device 252, respectively, the magnets could stabilize UAS in a position that places image capture device 252 in contact with and with a clear line of view through the car window. Similar principles could be employed to magnetically engage a metallic frame of a building window. Magnets could be permanent magnets, electromagnets, or a combination thereof. The strength of permanent magnets may be selected such that they are strong enough to stabilize UAS 200 in place, but not so strong that UAS 200 cannot safely disengage from the metallic structure (i.e., magnets strength<thrust available), which electromagnets could simply be turned on/off as desired. Another method of overcoming glare, this time without contacting the image capture device 252 against the window, is to block glare-inducing light from reaching the window or the image capture device aperture. To that end, in and such embodiment, UAS 200 may be equipped with a fixed or extendable visor at its front end to block this light (not shown). In deciding between a fixed or an extendable visor, one may consider that a fixed visor system may be lighter (no motor/actuators) and less costly (due to simplicity), however an extendable/visor system provides more control to the operator in terms of extending/retracting the visor for blocking light, for retracting the visor in tight quarters, and for retracting the visor to minimize any sail-like or download effects that may affect the aerodynamics of UAS 200. Yet another method of overcoming glare or window tint is to break the glass. To that end, UAS 200 may be equipped with a glass break mechanism (not shown). In various embodiments, the glass break mechanism may include a rigid pin and some form of actuator for propelling the pin forward with sufficient force to break the glass upon contact by the pin. In an embodiment, the actuator may be motorized, pneumatic, or the like, while in another embodiment, the actuator may be a trigger for releasing a spring that was manually compressed prior to flight. Of course, other embodiments of glass break mechanism suitable for this intended purpose are within the scope of the present disclosure as well.

In addition to payloads configured for collecting or facilitating the collection of information, UAS 200, in various embodiments, may further comprise payloads configured to directly implement a response to the event. For example, UAS 200 may be equipped with means for delivering offensive payloads, such as hard points for carrying, arming, and releasing flash-bang grenades or other munitions, including munitions for neutralizing suspected explosive devices. Similarly, UAS 200 may be equipped for carrying and dispersing gasses, such as pepper spray and other irritants. Notably, rotor wash from UAS 200 may be used to help disperse the gasses quickly. In yet another embodiment, UAS 200 comprise payloads for generating optical and/or audio effects for disorienting persons, such as bright strobe lights and speakers for producing extremely loud noises at frequencies known to disrupt cognitive function.

### UAS Vision-Based Hover Stabilization

The present disclosure is further directed to systems and methods for vision-based hover stabilization of an unmanned aerial system such as, but not limited to, UAS 200. Generally speaking, the vision-based hover stabilization system processes images captured by the image capture device to determine any flight control inputs necessary to hover in a substantially stationary position. A unique advantage of the vision-based hover stabilization system described herein is that it can be used in areas where conventional GPS-based hover stabilization techniques are ineffective due to a poor or non-existent GPS signal, such as indoors or underground. In various embodiments, the vision-based hover stabilization system may be configured to leverage the fact that there are likely to be a number of vertical and horizontal edges that can be detected by the algorithms and used for hover stabilization. No additional markers are required to be placed inside the building.

The vision-based hover stabilization system, in various embodiments, may generally include an unmanned aerial vehicle, an image capture device, an inertial measurement unit (IMU), a processor, and memory. An electro-optical or other suitable image capture device onboard the UAV may be configured to capture forward and/or side looking video at 30+Hz frame rate, as well as possibly downward looking and rear facing video. The video stream(s) may be processed, along with the UAV's onboard IMU data, according to algorithms configured to detect if the UAV has changed its 3D pose (e.g., drifted away from a desired hover location, altitude, and attitude. The fusion of micro-electro-mechanical (MEMS) IMU data and image analysis may be used to compensate the image analysis for pitch, roll and yaw as well as provide additional data input to the stabilization algorithms. The typical drift associated with IMUs can be calculated from the image analysis and then mathematically negated.

The micro-electro-mechanical (MEMS) IMU, which includes three-axes gyroscopes, accelerometers and magnetometers, provides angular rates (ω), accelerations (a) and magnetic field observations (h) with high rates (100 Hz) for position and attitude determination that are used as inputs into the image analysis as well as raw sensor data for fusion into the pose estimation. The flight control input signals will be modified in order to command the UAS's onboard flight controller to maintain a set pose. The processing of the video and IMU data can take place onboard the UAV (on-board processor) or offboard (offboard processor) if they can be sent to the offboard processor, processed, and returned to the UAS in sufficiently close to real-time (or near real-time). The processor, in various embodiments, may include a GPU or FPGA.

In operation, the vision-based hover stabilization system may first identify one or more nearby landmarks in the operating environment. In an embodiment, the operator may identify one or more of these landmarks using a graphical user interface (GUI) displaying imagery being captured by the image capture device(s) (e.g., image capture device 252). For example, the operator may view, on a display (e.g., display 314), that portion of the operating environment within the field of view of the image capture device, and select (e.g., via a touch screen of the display) one or more suitable landmarks visible in that imagery. In another embodiment, the system may be configured to automatically identify the one or more suitable landmarks using techniques known in the art, such as those used by digital cameras to identify objects on which to focus. The system may be programmed with criteria for identifying the most suitable landmarks.

Upon identifying the one or more landmarks, the system may subsequently capture images of the operating environment at a high frequency, and compare these subsequent images to one or both of: (i) images captured at the time of identifying the one or more landmarks (“baseline” images), and (ii) images captured after the baseline images but previous to the current image being evaluated (“preceding” images). In particular, in comparing a subsequent image to a baseline image or a preceding image, the system may evaluate the size of the landmark(s) in the subsequent image and the location of the landmark(s) within the subsequent image. These may then be compared to the size and location of the landmark(s) in the baseline and/or preceding image to determine whether and by how much the size and location of the landmark has changed within the period of time that elapsed between the images being compared. These differences can be used to determine whether the location, altitude, or attitude of the UAS has changed. For example, for a front-facing image capture device, if the landmark(s) appear smaller in the subsequent image, the system may determine that the UAS may be drifting away from the landmark and thus the desired hover location; if the landmark(s) have shifted right within the imagery, then the UAS may be drifting left from the desired hover location and/or yawing left from the desired hover attitude; if the landmark(s) have shifted up within the imagery, then the UAS may be descending from the desired hover altitude; and so on.

In various embodiments, the system may further utilize the IMU information to confirm what it believes it has determined from the imagery. For example, the system may evaluate whether an acceleration occurred during the elapsed timeframe, and compare the direction of that acceleration with the predicted direction of movement of the UAS based on the above-described imagery comparison. Likewise, the system may evaluate any changes in pitch, roll, or yaw angle during the corresponding time period. For example, if the IMU detects a nose-down pitch angle and the landmark got larger in the corresponding imagery, it may deduce that the UAS has translated forward from the desired hover location.

The system may be configured to automatically adjust the flight controls of the UAS to compensate for perceived migrations from the desired hover pose. In an embodiment, the magnitude of correction may be proportional to the magnitude of changes perceived in landmark size and position within the imagery. Given the high sampling rate of imagery and corresponding comparisons, it is possible to incrementally adjust the flight controls and revaluate frame-by-frame. This may ensure that the system does not overcompensate. Likewise, the system may calculate the magnitude of adjustment using the IMU data. For example, the system may estimate a distance the UAS traveled over a given time period by integrating acceleration into velocity and then multiplying that velocity by the time elapsed (i.e., distance=rate*time). The system may then make flight control adjustments to move the UAS a corresponding distance in the other direction. It should be recognized that compensation approaches utilizing IMU data may require less frequent sampling that imagery-based compensations, which could save processing bandwidth and reduce power consumption.

### Portable Communications System 300

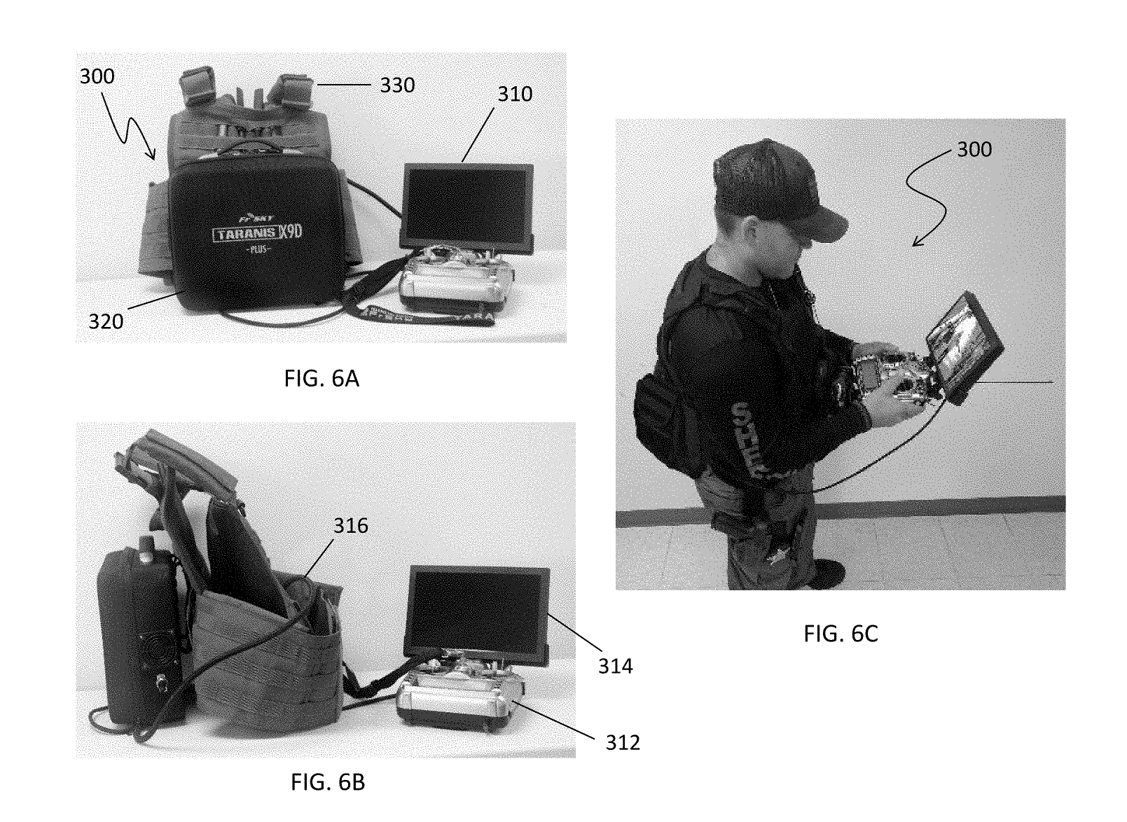

FIGS. 6A-6C illustrate a representative embodiment of portable communications system 300 of event response system 100. Portable communications system 300 integrates UAS control and remote data transmission into a compact package that is wearable by the UAS operator. As configured, portable communications system 300 allows for local control of UAS 200 while simultaneously serving as a platform for distributing information collected by UAS 200 to local responders and remote responders alike.

This system architecture offers unique benefits to event response system 100, especially in terms of ensuring low-latency streaming of high-quality video and other important information to any relevant responders in real-time (or near real-time), regardless of their location. Consider, for example, a situation in which a SWAT team has initiated full breach in response to a hostage situation in a building, especially one with thick walls or a basement where wireless signals have trouble penetrating. As the SWAT team clears the building room-by-room, it may fly UAS 200 ahead to identify potential threats. Given the likely close proximity of the SWAT team to UAS 200, UAS 200 may directly stream captured video to wearable devices 400 (e.g., wrist displays) worn by the SWAT team without issue. However, there may be times that the operator and the SWAT team intentionally or unintentionally separate from one another, in which case the short-range or medium-range transceiver on UAS 200 may not be suitable for transmitting the video feed and other information to the SWAT wearable devices 400. Thus, in some embodiments, the video feed and other information may be selectably routed from UAS 200 wearable device(s) 400 via portable communications system 300. It would also be unlikely that UAS 200 could provide the video stream directly to event response server 600 with comparable quality and speed without using a far more high-powered and sophisticated transmitter/transceiver, given the distances to be covered and the difficulty of transmitting a signal out of the building. Such a high-powered transceiver would add significant weight, bulk, and cost (including associated increases of each due to additional power consumption and larger propulsion systems) to UAS 200, perhaps to the point of rendering UAS 200 incapable of performing its mission, too big to be effectively carried by the operator, and/or too costly for the system to be adopted (especially considering UAS 200 may be shot at or otherwise subject to damage/destruction). Accordingly, by offloading remote transmission duties (i.e., transmission to event response server 600 and remote devices 500) from UAS 200 to portable communications system 300, UAS 200 can be inexpensive, compact, and lightweight, without sacrificing the many benefits explained above for the particular design described and set forth in connection with FIGS. 4A-4C and 5A-5B. State otherwise, it is far easier, inexpensive, and effective for the operator to carry the equipment necessary for transmitting video and other data to event response server 600 than to include this equipment on UAS 200.

Still, this equipment must be carried by the operator in addition to the controller used to pilot UAS 200. To assist the operator in comfortably carrying this load and keeping the operators hands free to fly UAS 200, portable communications system 300, in various embodiments, may be configured to be worn by operator. A representative embodiment of such a portable communications system 300 is illustrated in FIGS. 6A-6C. Portable communications system 300, in various embodiments, may include a controller 310 for operating UAS 200, hardware 320 for receiving video and other information from UAS 200 and transmitting it to event response server 600 (and in some cases, to wearable devices 400), and a tactical vest 330. As shown in FIG. 6B, controller 310 may comprise a wireless remote control 312 configured with joysticks or other mechanisms for receiving flight control inputs from the operator, along with a display 314 for displaying the video feed from image capture device 252 of UAS 200. Referring to FIG. 6A, hardware 320 may be packaged up into a housing that is, in turn, attached to the back of tactical vest 330. This configuration allows the operator to comfortably carry hardware 320 on his or her back, while also leaving the operators hands free to carry UAS 200 or to pilot UAS 200 using controller 310, as shown in FIG. 6C. A cable 316 may provide the UAS video feed to controller 310 for display to the operator on display 314, as described in more detail below.

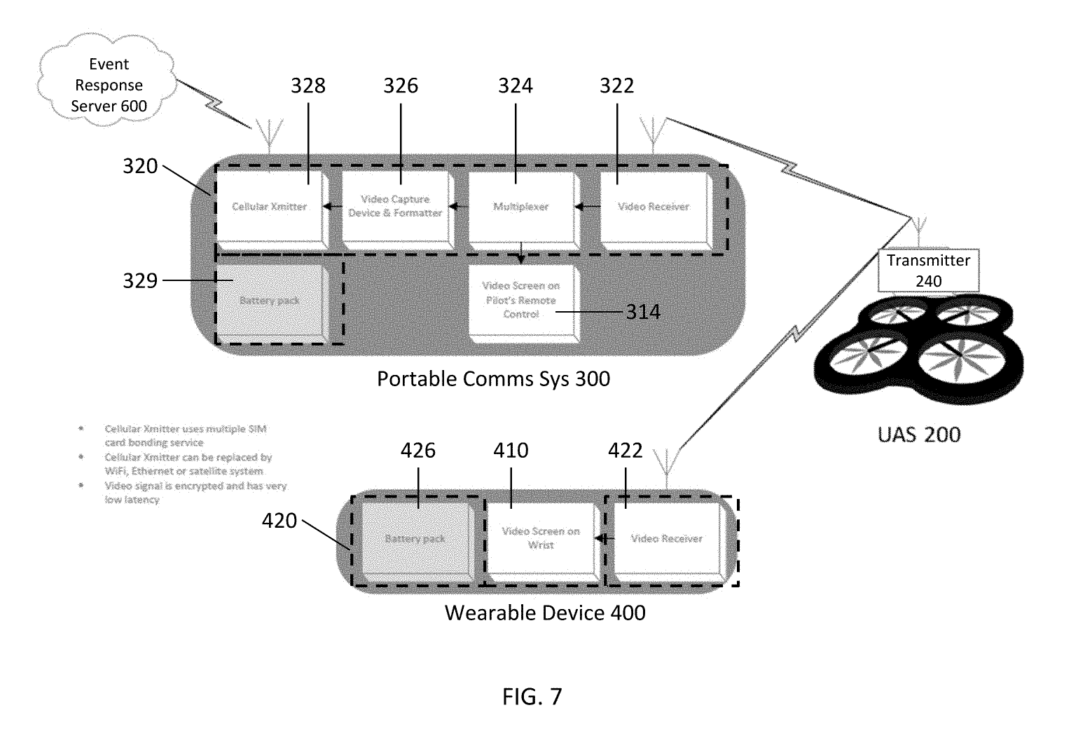

Referring now to FIG. 7, in various embodiments, hardware 320—represented schematically as the area enclosed by the dashed lines—may include a video receiver 322, a multiplexor 324, a formatter 326, one or more transmitters 328, and a power source 329. As shown, video receiver 322 may be configured to receive the video feed (and or feed of other information collected) from UAS 200. Multiplexor 324, in various embodiments, may distribute the video feed via cable 316 for display on display 314 of controller 310, and also distribute the feed to formatter 326, where it is formatted and possibly encrypted for transmission to one or both of wearable devices 400 and event response server 600 via transmitter(s) 328. As previously referenced, in embodiments where the feed is to be transmitted to wearable devices 400, transmitter 328 may be a Wi-Fi transmitter or similar, and in embodiments where the feed it to be transmitted to event response server, transmitter 328 may be a cellular or satellite transmitter. Power source 329, such as a battery pack, may provide power to hardware 320 (and possibly controller 310 via cable 316).

### Wearable Device 400 and Remote Device 500

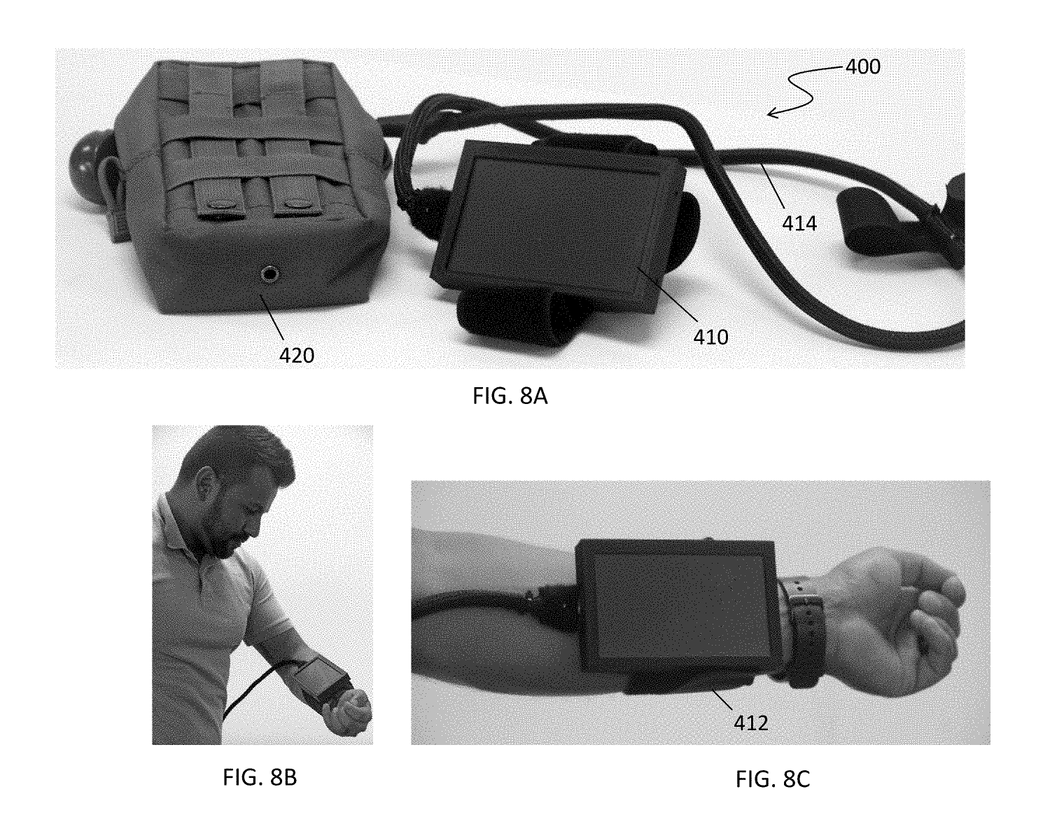

FIGS. 8A-8C illustrate a representative embodiment of wearable device 400 of event response system 100. Wearable device(s) 400 is a wearable device configured for displaying information to local responders to enhance the responder's situational awareness about the event and/or event response. To that end, wearable device(s) 400 may include a display 410 for displaying the information to the responder, and hardware 420 for receiving a wireless signal carrying the information. As shown in FIG. 8C, display 410 may comprise a coupler 412, such as an elastic or Velcro strap, for attaching display 410 to the responder's body. In the embodiment shown, display 410 has dimensions suitable for mounting on the responder's forearm. This can be a convenient location, as the responder can easily view display 410 as he or she may look at a wristwatch. A further advantage of mounting display 410 to the inner forearm, is that the responder (e.g., a law enforcement officer) can view the display 410 without his or her head while aiming a pistol or rifle. In an aiming stance with either weapon, the inner forearm associated with the leading hand naturally comes into the field of view—a simple side glance of the eyes is all that is necessary to view the display 410 in this position. Referring back to FIG. 7, hardware 420 may include a receiver 422 for receiving a wireless signal transmitted from UAS 200 and a formatter 424 (not shown) for formatting the video feed and other information carried by the wireless signal for display to the responder via cable 414 connecting hardware 420 to display 410. Hardware 420 may further comprise a power supply 426 for powering components of hardware 420 and/or display 410. Hardware 420, in an embodiment, may be packaged into a housing (e.g., hip pouch) that may, in turn, be worn on the body of the responder or on tactical vest 330 of portable communications system 300.

It should be noted that wearable device 400, in addition to receiving and displaying substantially unprocessed video/information from UAS 200, may in some embodiments be configured to display processed intelligence generated by event response server 600. In such an embodiment, processed intelligence may be transmitted from event response server 600 to portable communications system 300 along communications link 130, and then to wearable device 400 along communications link 120. For example, a map generated by event response server 500 using information gathered by UAS 200 could be sent to wearable device 400 via portable communications system 300 for display to an on-scene responder for assisting the on-scene responder in planning next steps in response to the event.

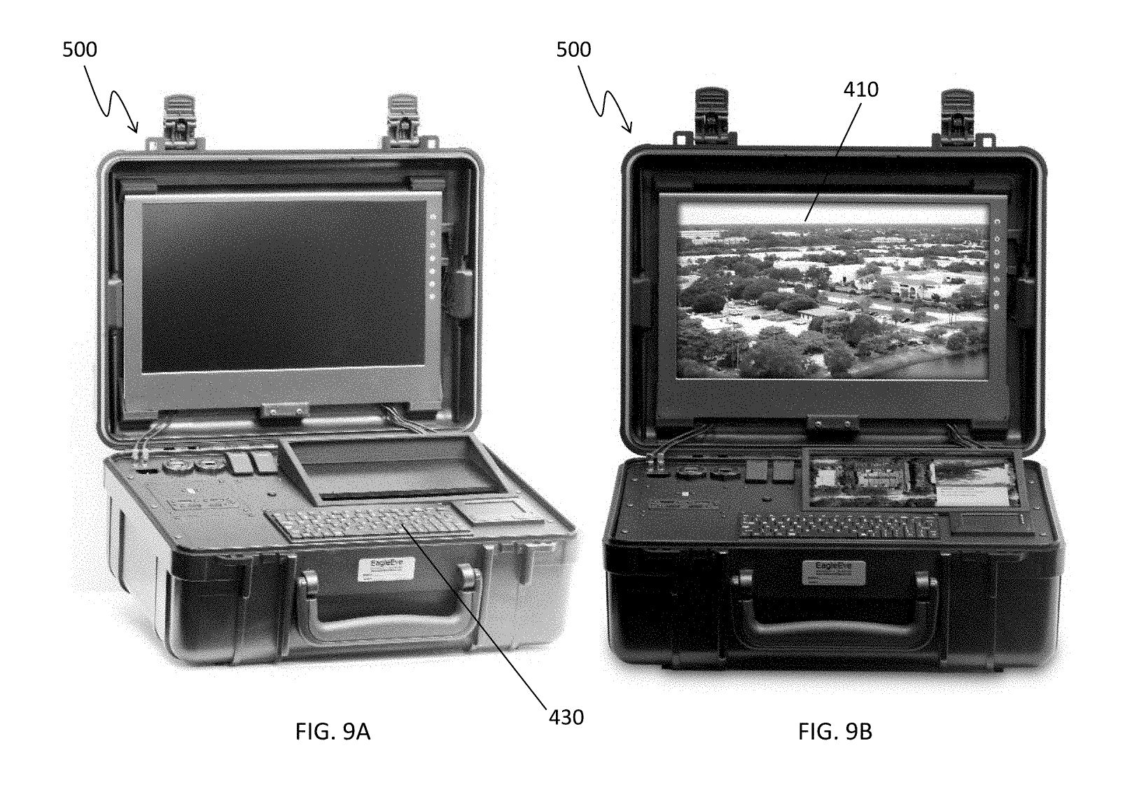

FIG. 9A and FIG. 9B illustrate a representative embodiment of remote device 500 of event response system 100. This particular embodiment is a portable package that can be deployed by responders in a variety of locations, but it should be recognized that remote device 500 may include any device capable of displaying information from event response server 600 and, in some embodiments, interfacing with event response server 600. In various embodiments, remote device 500 may include fixed-position devices (e.g., a computer at a RTCC), semi-mobile devices (e.g., a computer in a mobile command truck), and mobile devices (e.g., the portable deployment package shown, as well as smart phones, tablets, laptop computers, etc.). Remote device 500 may be configured with hardware 420 (not shown) for wired/wireless connection to event response server 600, as well as a display 510. In various embodiments, remote device 500 may be configured with an interface 430 (e.g., internet browser or mobile application) for interfacing with event response server 600. The internet browser or mobile application may be configured to process the video feed and other information sent from event response server for display, as well as receive inputs from a responder operating the remote device 500. For example, as later described in more detail, remote device 500 may be configured to allow the responder to interface with event response server 500 in order to build maps and other processed intelligence, as well as to designate and assign roles to various other responders. In essence, remote device 500, in various embodiments, may be configured to interface with event response server 600 in ways that allow the responder to perform command and control functions for orchestrating the overall event response.

### Event Response Server 600

Event response server 600 of the present disclosure serves numerous functions including, without limitation, coordinating the distribution of video and other information collected by UAS 200 to remote devices 500, integrating communications and other information into a common operating picture for enhancing situational awareness of responders, and generating additional forms of intelligence from various sources of information (“processed intelligence”) for distribution to responders.

Processed intelligence, as used in the present disclosure, broadly includes manipulations, aggregations, and/or derivative works of information gathered from various sources of information. An illustrative example of processed intelligence are maps and other visual aids showing the event environment and possibly the locations and movements of persons or objects associated with the event, as further described below. Another illustrative example of processed intelligence is a compilation of information about persons or objects associated with the event, such as a suspect identified in UAS 200 video via facial recognition techniques, as further described below. Information used to generate processed intelligence can come from any number of sources, including UAS 200, body cameras, security cameras, beacons, sensors, and public databases, amongst others. As further described below, various modules of event response server may work together to manage and process such information to generate the processed intelligence. For example, a media manager may be configured to support, format, and process additional sources of video, a location manager may be configured for managing and integrating additional sources of location information regarding persons or objects associated with the event, a data manager may access various databases to retrieve criminal records or other useful information, and a communications manager may manage and integrate numerous types of communication mediums from various persons associated with the event.

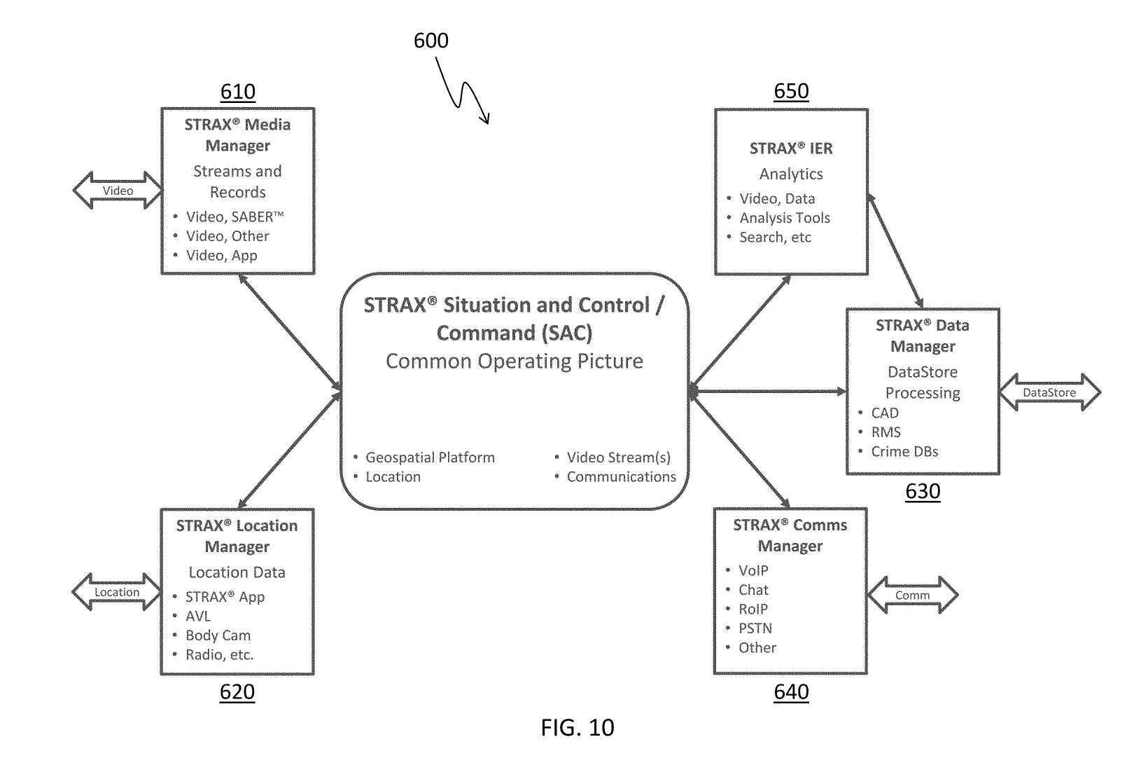

Referring now to FIG. 10, illustrated is a representative embodiment of event response server 600 of event response system 100. Event response server 600 may include one or more modules that may operate individually or in combination to manage various aspects of event response system 100. In the representative embodiment shown, event response server 600 may generally include media manager 610, location manager 620, data manager 630, communications manager 640, and intelligent event response manager 650.

Media manager 610, in various embodiments, may support and manage the various types of media provided to event response server 600 to help responders understand and respond to the event. For example, media manager 610 may be configured for supporting video streaming from UAS 200 and other sources like body cameras, dash cameras, smart phone cameras, security cameras, and other devices capable of capturing and transmitting video to event response server 600 that may be helpful in enhancing the situational awareness of responders associated with the event.

In particular, in various embodiments, media manager 610 may manage the registration and configuration of a specific end device (e.g., wearable device 400 or remote device 500). Media manager 610, in various embodiments, may also manage the connection request and negotiation of the video feed format and embedded KLV information and location information. In cases where location information is not contained within the embedded KLV stream, media manager 610 may separately manage connection and negotiation particulars for location information. Media manager 610, in various embodiments, may additionally or alternatively monitor connection and recording connection information such as signal strength, bandwidth availability, bandwidth use, and drops in connection. Still further, media manager 610, in various embodiments, may additionally or alternatively report connection information and/or issues enabling users to understand any performance issues so they can adjust their response strategy accordingly. Additionally or alternatively, media manager 610, in various embodiments, may format video and other information received from UAS 200 for compatibility with various analytics engines (e.g., format the video for compatibility with facial recognition software). In such cases, media manager may create a copy of the video stream or information received from UAS 200 and format the copy, thereby allowing the original feed to continue undisturbed for other purposes.

Location manager 620, in various embodiments, may support and manage information concerning the locations of responders, assets (e.g., UAS 200, police cars, ambulances), and other persons and objects (e.g., suspects, hostages, bystanders, contraband, suspected explosive devices) associated with the event and/or event response. Location information can greatly enhance the situational awareness of responders, and thereby help responders plan and execute a coordinated response to the event.

Location information may come from a variety of sources. One potential source of location information is from beacons or other forms of geolocating technologies included in various devices. For example, location manager 620 may support and manage location information transmitted to event response server 600 from locator beacons worn by responders or installed in various assets like police cars or UAS 200. Likewise, location manager 620 may support and manage location information of responder, suspects, hostages, and other persons based on technologies used to determine the location of their cellular phones or other telecommunications devices (e.g., signal triangulation, extraction of GPS data). Location manager 620, in various embodiments, may be configured to automatically receive, request, fetch, or otherwise obtain and update location data from many types of electronic devices, thereby offloading the task from responders and ensuring that the location information is current. Another potential source of location information is from the responders themselves. In an embodiment, location manager 620 may be configured to interface the back end of a mobile application operating on a responders device, such that it can receive location information manually input into the mobile application by the responder. For example, if a police officer witnessed suspect ditch contraband or weapons while fleeing, the police officer could mark the location on the mobile application and continue chasing the suspect, as location manager 620 could provide the marked location to other units for recovery. Likewise, in another example, a responder monitoring the event remotely (e.g., watching video feed from UAS 200 at a RTCC) may manually input (e.g., into remote device 500) the locations of suspects or hostages that he or she views in the video feed. One of ordinary skill in the art will recognize that these are but a few examples of many potential sources of location information available to location manager 620, and that the present disclosure is not intended to be limited to any particular source or classification of sources.

Location manager 620, in various embodiments, may aggregate and process location information received by event response server 600 in a variety of ways the help to enhance the situational awareness of responders to an event. In one aspect, location manager 620 may be configured to provide location information for visual for presentation to event responders. In one such embodiment, location manager 620 may aggregate and format location information (e.g., associate the location information with coordinates and scale of a map) such that the locations of relevant persons, assets, and/or objects can be overlaid on maps or other visual aids and displayed to responders on one or both of remote device 500 and wearable device 400. In another aspect, location manager 620 may support intelligent event response module 650 (later described) in determining the priority of the event, whether additional responders or assets are needed, and which roles various responders should play based, at least in part, on their geographic locations. In some embodiments, location manager may be configured to update this location information continuously throughout the response to the event (as available from the sources of the location information), ensuring that maps, event priority, responder roles, and the like constantly reflect the latest available location information. Location manager 620, in some embodiments, may also be configured to convert location information to specific coordinate systems using established coordinate system conversions.

Data manager 630, in various embodiments, may interface with one or more databases for retrieving information related to the event and event response. Data manager 630 may retrieve this information responsive to user requests and/or automated requests from intelligent event response module 650. For example, in various embodiments, data manager 630 may be configured to access various government databases (e.g., criminal records, crime databases, emergency services databases, public works databases, geographic information systems (GIS)) and private databases (e.g., those containing things like records of previous events) to extract useful information. For example, in an embodiment, data manager 630 may be configured to retrieve criminal records on suspects identified in the video feed streamed from UAS 200, thereby allowing responders to better understand who they are dealing with and the potential threat level the suspect may pose. The suspects, in an embodiment, may be automatically identified via facial recognition software, and in another embodiment, may be identified by responders who recognize the suspect. As another example, data manager 630 may be configured to retrieve pre-planned response guidelines for a particular type of event, thereby expediting the response to the event, which could save lives. Search properties and other request-related inputs are typically managed by data manager 630.

Communications manager 640, in various embodiments, may be configured for managing the flow of communications amongst responders throughout the response to the event. Responders to the event may exchange information with one another through a variety of mediums such as voice calls (e.g., cellular, landline, VoIP), radio calls (e.g., standard radio chatter, push-to-talk, RoIP), text messages (e.g., MMS, SMS), chat messenger applications, and the like. Communications manager 640 may be configured to establish communications links with devices used by the responders, send requests for information, and receive pushed information, amongst other related tasks.

Communications manager 640 can prioritize certain communication channels based on one or more parameters, such as the responder role, event type, location. For example, communications manager 640 might prioritize an inter-agency voice channel for the sheriff and a RoIP channel for a deputy. Additionally or alternatively, communications manager 640 may combine communication channels. For example, Responder A is added to the event via a PSTN call, Responder B is using remote device 500 and is joined via the embedded VoIP capabilities, Responder C is joined via a RoIP channel, but they all need to communicate with each other. Communications manager 640 may translate the origination format of the communications channel and distribute it to the destination in the proper format. This is also possible for different types of communication. For example, a chat message can be turned into a voice message and played, and voice can be turned into text and displayed.

Intelligent event response (IER) module 650, in various embodiments, may be configured to integrate relevant information from media manager 610, location manager 620, data manager 630, and communications manager 640 into a common operating picture for enhancing the situational awareness of responders.

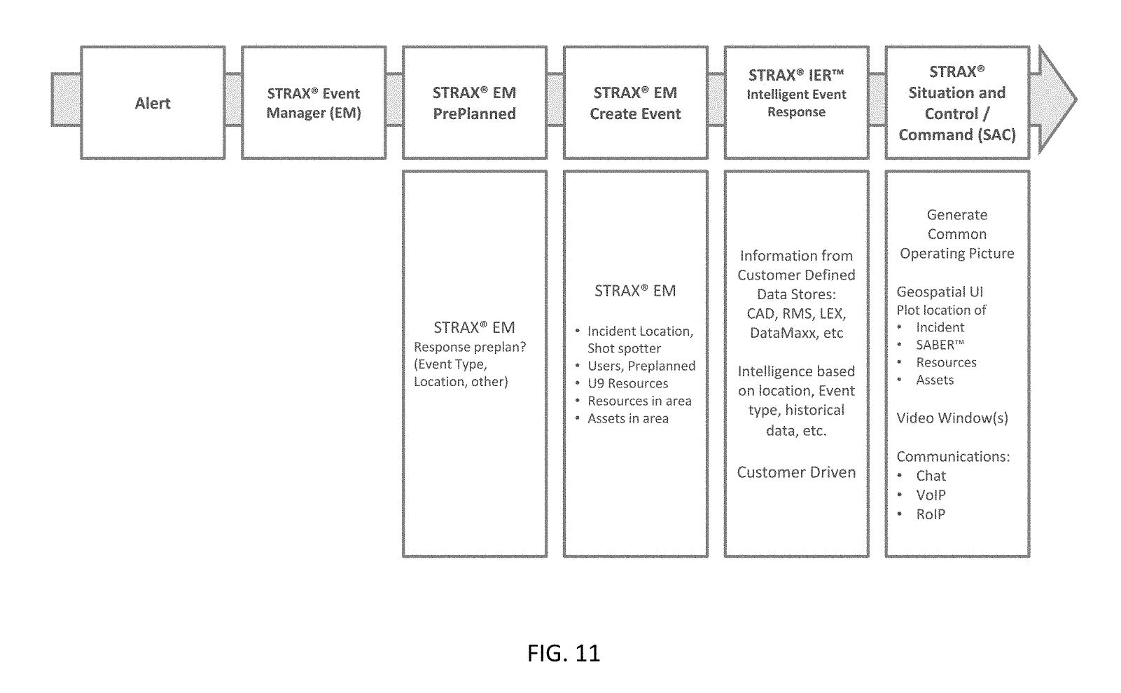

Referring now to FIG. 11, IER module 650, in various embodiments, may be configured for routing the information in accordance with workflows based on the nature and priority level of the event. For example, IER module 650 may be configured to determine whether an incoming event is low, mid, or high priority based on various criteria, such as the risk of bodily harm or death to persons involved in the event. Priorities may also be set according to agency policies. IER module 650, in various embodiments, may use a complex rules engine so the assigning of a priority can be based on any combination of the varying event characteristics. Priority can be set based on something as simple as the event type or as complex as event type, location, assets needed, resources needed etc. Information provided by a responder, such as a notification that a suspect has a weapon, could be used to set or change the priority of the event. Event priority may be changed at any time throughout the event so as to efficiently manage responder resources.

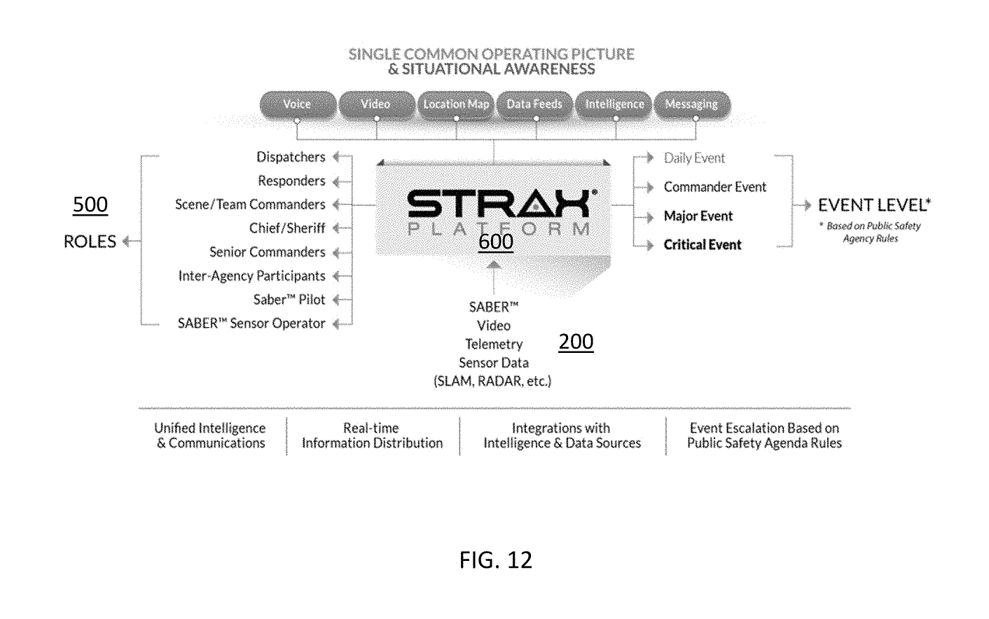

Referring now to FIG. 12, IER module 650, in various embodiments, may be configured for assigning roles to the various responders and routing relevant information to each of them in accordance with workflows corresponding with the roles assigned to each. Assignment of event roles may be based on agency policies and do not necessarily have to align with the default roles assigned to a specific resource. Again, in some embodiments, IER module 650 uses a complex rules engine to enable agencies to assign responder roles as needed for a particular situation. Any information/data available to the system can be used for this assignment. However, the equipment assigned is usually assigned based on training, certifications, and need associated with a resources responsibility within the agency. Normally, a piece of equipment can be associate with a responsibility which is normally aligned with a default assigned Role (i.e. SWAT, K-9, pilot) which may or may not align with their assigned response role in a particular event. However, it is feasible that the state of a piece of equipment can be used to set or modify the responder role. For example, one pilot relinquishes control to another pilot, or a portable device drops from the event and a new one must be assigned to the responder role.

IER module 650, in various embodiments, may be configured to send different information to devices associated with different roles. For example, responders using remote devices 500 in an intelligence analyst or communications role may logically be provided with relatively detailed information from multiple sources, as these responders may be responsible for managing a larger portion of the event response. Devices (e.g., wearable device 400) associated with field responders, on the other hand, may receive more distilled information, possibly from fewer sources, as these responders are typically more focused on responding to a specific element of the event that is assigned and coordinated by back-end responders. For example, a commander may have access to 30 video streams, data from multiple feeds, communications links to multiple groups both intra- and inter-agency, while a front-line responder may have 1-3 video streams, specific information derived from multiple data streams, and only a single communications link.

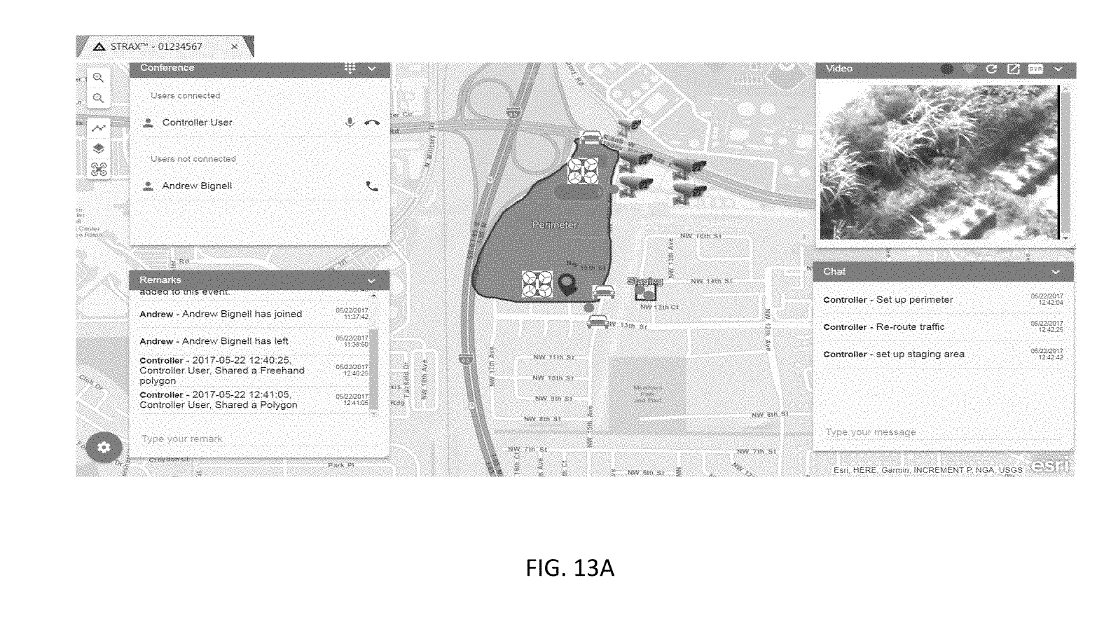

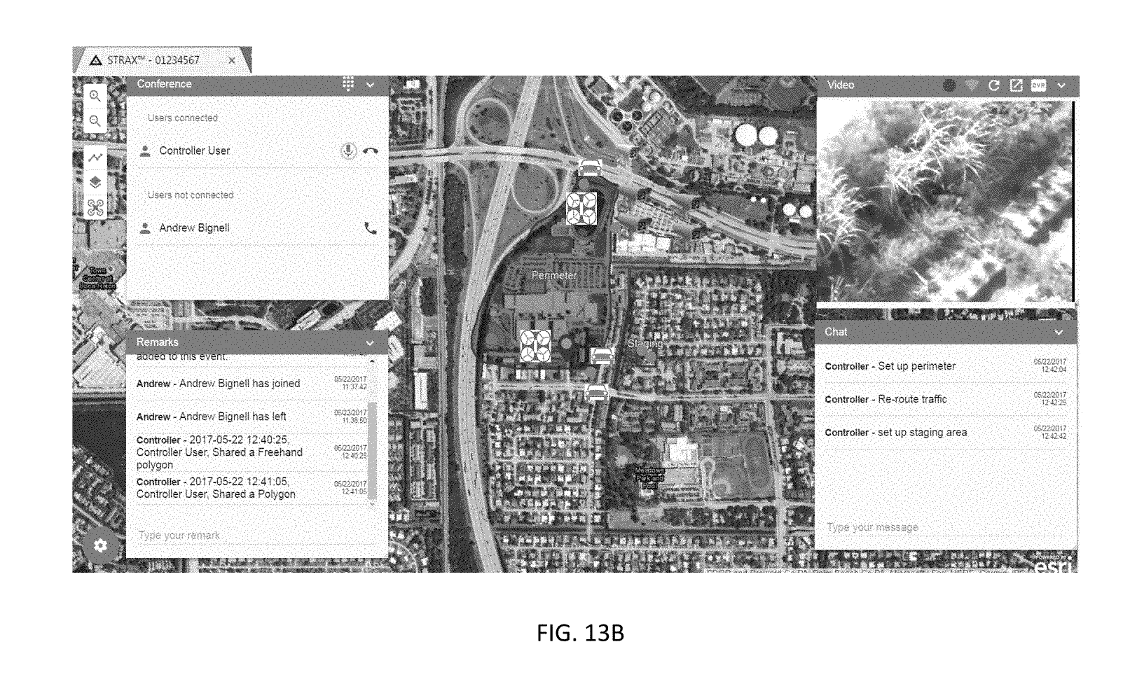

Referring now to FIG. 13A and FIG. 13B, IER module 650, in various embodiments, may additionally or alternatively provide a front-end interface between responders and event response server 600 for facilitating responders in planning and executing an effective response to an event. In an embodiment, IER module 650 may provide an interface for building maps or other visual aids for visually communicating information location to responders. For example, the interface may be configured to overlay locations of relevant persons and objects onto satellite imagery or building blueprints/floor plans. These maps can be 2-D or 3-D, depending on the information available. The maps, in some embodiments, may be interactive such that a responder can alter the view and/or information presented on the map. For example, in an embodiment, the IER interface may allow the responder to toggle various layers of the map, such as the base map layer (e.g., toggle between satellite and blueprints) and the location information layers (e.g., add/remove location information for one or more classifications of persons or objects). As another example, in an embodiment, the IER interface may be configured to allow the responder to change the view of the map from birds-eye to side view, thereby allowing the responder to monitor location information on various floors of the building and to identify access points between stories, such as stairs. The IER interface may be further configured to allow the responder to select a given floor and load it from a bird-eye view perspective, ignoring floors above it.

IER module 650, in various embodiments, may provide an interface for building Simultaneous Localization and Mapping (SLAM) maps using geospatial information (e.g., location, orientation) and video feeds provided by UAS 200, body cameras, and other sources. This is particularly useful if satellite imagery, blueprints, floor plans, or other visual aids are unavailable or outdated for the particular target environment, as UAS 200 operator and other responders may lose orientation and position within the target environment.

As a responder flies UAS 200 through the target environment, IER module 650 may automatically or with user input build a SLAM map of the target environment using information transmitted from UAS 200. A type of two-dimensional blueprint of the target environment may be built and superimposed on top of a commercially-available GIS display, such as Bing or Google maps or ESRI. The SLAM map may be continuously updated as the UAS 200 is navigated through the target environment, and can be configured to display breadcrumbs of where the UAS 200 has been. The operator and/or responders can annotate the SLAM map in real-time, for example, to show which areas (e.g., rooms) of the target environment (e.g., building) are clear and which ones contain potential threats.

Off-the-shelf algorithms and sensor suites may be used to facilitate SLAM mapping. For example, processors onboard UAS 200 or in event response server 600 may process the imagery captured by UAS 200 and other sources (e.g., body cameras, security cameras, etc.) to identify common structure (e.g., walls, windows, doors) and/or objects that may serve as references for understanding the layout of the target environment. Reference structure/objects identified from the imagery may then be associated with geospatial information (e.g., location, orientation) available about the source of the imagery (e.g., the location and orientation of the UAS 200, the body camera, the security camera, etc.). In some embodiments, distance measurements between the reference structure/objects and the source of the imagery may be measured (e.g., via a laser or ultrasonic range finder onboard UAS 200 or paired with the body camera, security camera, etc.) or otherwise estimated, and then associated with the imagery and geospatial information about the imagery source. As configured, it is possible to build a blueprint-like map of an unknown environment with fairly reliable scale measurements. In an embodiment, IER module 650 may be configured to scale and/or orient the location information/video imagery for overlay onto these base maps.

UAS 200 may be equipped with various payloads for collecting the location telemetry information (e.g., attitude, altitude, velocity), such one or a combination of an IMU, a time-of-flight range finder, a laser range finder, a solid state radar, or an ultrasonic sensor. Video feeds may be captured by any suitable imagery devices, such as an electro-optical camera(s) (e.g., image capture device 252). In an embodiment, some of the location information and/or video feed may be processed on UAS 200 itself and then transmitted offboard to more powerful processors (e.g., GPU, FPGA).

### Representative Use Cases

Breach:

SWAT teams A and B breach building from ground floor and roof, respectively. MPC operators breach with SWAT teams and fly drones ahead while clearing building. MPCs transmit video feeds with their team's SWAT wearable screens and SWAT team members view before entering next room. MPCs also transmit video feed and location information (e.g., of drones and/or MPCs) with ERS. Command and control guys take leadership role, and from remote device: 1) observe progress of SWAT teams A and B, and 2) instruct each team based on map generated by STRAX with location information transmitted from the MPCs. Drone A locates a tango at top of stairwell (“funnel of death”) and command center vectors SWAT team B to go take him out so SWAT team A can safely ascend. Add scenario where drone hovers and covers their six o'clock using the hover stabilization technology. Add scenario where map is sent to swat devices for even more enhanced understanding of the rooms they are about to clear.

Bomb Threat:

Drone operator enters stadium and flies drone around looking for suspicious package while keeping a good distance away. Flies drone to look under seats and into bathroom stalls from underneath the door. Process goes way faster than manual search methods and use of traditional bomb disposal robots. Way safer as keep distance. Can follow up with dogs and such after initial assessment with drone. Command and control uses map to guide operators around and ensure all areas are cleared.

Suspicious Vehicle 1:

Suspicious vehicle approaches sensitive area. Drone operator approaches vehicle and flies drone up to heavily tinted window. Engages window with flexible skirt/extendable visor to cut glare and image capture device gets look inside. Nothing suspicious is seen. No damage occurs and assets are not unnecessarily diverted.

Suspicious Vehicle 2:

Suspicious vehicle parked outside of embassy, looks really weighed down. Drone operator approaches vehicle and flies drone up to heavily tinted window. Engages window with flexible skirt/extendable visor to cut glare and image capture device gets look inside. Suspicious wiring is viewed. Drone breaks window with window break pin and gets a better view of the wiring for bomb tech. Drone flies up into overwatch position while bomb tech approaches. Suspicious person with video image capture device is spotted, possibly has bomb trigger and is making propaganda video. Operator flies drone towards suspicious person for a better look while bomb tech retreats. Suspicious person apprehended, revealing trigger device. Bomb tech then safe to dispose of car bomb. This showcases the benefits of a drone over a ground robot—never would have been able to engage suspicious person as quickly and effectively.

Other:

Use of UAV to provide ‘eyes’ for a law enforcement team prior to and during the entry of building or vehicle. For example, The UAV can act as a forward spotter and can be used to ‘clear’ rooms in advance of SWAT team entry.

The UAV can enter a building or room, land in the room and provide real-time (or near real-time) video back to law enforcement personnel in a safe environment. The video can be from the forward facing image capture device or from other sensors, such as a 360 degree view image capture device. Audio can also be sent back to the law enforcement personnel for audio monitoring in a room or building. All lights and sounds on the UAV can be suppressed once it has landed during covert operation scenarios.

Unlike the law enforcement's existing robot platform, the UAV can easily enter a building though a breached window, particularly valuable in multi-floor buildings.

The UAV can be used in outdoor environments to approach vehicles and objects for close quarters inspection using the video feed from image capture device(s) on UAS 200.

The UAV can be used for container or tank inspection. Use of object detection technology and collision mitigation system in place, there are reduced changes of damage or loss of UAV due to collisions.

Add-on modules may enable the UAS to pick up and drop small objects. This could be particularly useful in hostage negotiation situations.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

What is claimed is:

1. A system for remotely displaying video captured by an unmanned aerial system (UAS), the system comprising:
an unmanned aerial system (UAS) including an unmanned aerial vehicle (UAV), one or more image capture devices coupled to the UAV for capturing video of an environment surrounding the UAV, and an onboard transmitter for transmitting a short-range or medium-range wireless signal carrying the video of the environment surrounding the UAV;
a portable communications system including a receiver for receiving the short-range or medium-range wireless signal transmitted from the UAS and a transmitter for transmitting a long-range wireless signal carrying the video of the environment surrounding the UAV to a wide area network (WAN); and
a server in communication with the WAN, the server being configured to share the video of the environment surrounding the UAV with one or more remote devices for display on the one or more remote devices.

2. A system as set forth in claim 1, wherein the onboard transmitter and the receiver are Wi-Fi radios and the short-range or medium-range wireless signal is a Wi-Fi signal.

3. A system as set forth in claim 1, wherein the transmitter is one of a cellular transmitter or a satellite transmitter, and the long-range wireless signal is one of a cellular signal or a satellite signal, respectively.

4. A system as set forth in claim 1, wherein the video of the environment surrounding the UAV is shared with the one or more remote devices in real-time or near real-time.

5. A system as set forth in claim 1, wherein the portable communications system further includes a controller for remotely piloting the UAV and display for displaying the video of the environment surrounding the UAV.

6. A system as set forth in claim 1, wherein the onboard transmitter is configured to transmit a second short-range or medium-range wireless signal carrying the video of the environment surrounding the UAV for display on one or more wearable devices situated proximate the UAS.

7. A system as set forth in claim 1, wherein the one or more remote devices are configured to receive and display the video of the environment surrounding the UAV via an internet browser or mobile application.

8. A system as set forth in claim 1,
wherein the UAS is further configured to transmit, to the server via the short-range or medium-range wireless signal and the long-range wireless signal, information concerning at least one of a location, an attitude, and a velocity of the UAV,
wherein the server is configured to associate the information concerning at least one of the location, the attitude, and the velocity of the UAV with coordinates and scale of a corresponding map for sharing with the one or more remote devices, and
wherein a browser or mobile application running on the one or more remote devices is configured to display a map showing the corresponding location, attitude, and velocity of the UAS.

9. A system as set forth in claim 8,
wherein the server is further configured to associate information concerning a location of one or more persons or objects with the coordinates and scale of the map for sharing with the one or more remote devices, and
wherein the browser or mobile application running on the one or more remote devices is configured to display the corresponding locations of the one or more persons or objects on the map.

10. A system as set forth in claim 1,
wherein the UAS is further configured to transmit, to the server via the short-range or medium-range wireless signal and the long-range wireless signal, information concerning at least one of a location, an attitude, and a velocity of the UAV, and
wherein the server is configured to identify reference structure in the video of the environment surrounding the UAV and associate the reference structure with the information concerning at least one of the location, the attitude, and the velocity of the UAV to generate a Simultaneous Localization and Mapping (SLAM) map of the corresponding environment surrounding the UAV.

11. A system as set forth in claim 1,
wherein the server is configured to process the video of the environment surrounding the UAV to identify persons or objects present in the video, and
wherein the server is further configured to retrieve information associated with the identified persons or objects from one or more databases for sharing and display on the one or more remote devices.

12. An unmanned aerial system (UAS), comprising:
an unmanned aerial vehicle (UAV) comprising:
a substantially rectangular and flat airframe,
four rotors situated in-plane with the airframe, the four rotors being positioned proximate each of four corners of the substantially rectangular and flat airframe, and
first and second handholds integrated into opposing peripheries of the airframe and situated along a pitch axis of the UAV between those two of the four rotors positioned adjacent to each of the first and second handholds along the corresponding periphery of the airframe;
one or more image capture devices coupled to the UAV for capturing video of an environment surrounding the UAV; and
a transmitter for transmitting a wireless signal carrying the video of the environment surrounding the UAV.

13. A UAS as set forth in claim 12, wherein the airframe has a height dimension substantially equal to a height of the four rotors situated in-plane with the airframe.

14. A UAS as set forth in claim 12, wherein the airframe forms circular ducts about each of the four rotors.

15. A UAS as set forth in claim 12, wherein each of the first and second handholds includes a hollow cutout extending through the airframe near an outer edge of the corresponding periphery.

16. A UAS as set forth in claim 12, further comprising a flexible skirt for assisting an operator in stabilizing the image capture device against a window to reduce glare.

17. A UAS as set forth in claim 12, further comprising one or more magnets configured to magnetically engage a metallic surface for stabilizing the UAV in place proximate the surface.

18. A UAS as set forth in claim 12, further comprising a glass break mechanism.

19. A UAS as set forth in claim 12, further comprising a vison-based control system for automatically adjusting one or more flight controls to stabilize the UAV in hover, the control system comprising a controller configured to:
identify one or more landmarks present in the video of the environment surrounding the UAV,
evaluate a size and location of the one or more landmarks in the video at a first point in time,
evaluate a size and location of the one or more landmarks in the video at a second, subsequent point in time,
compare the size and location of the one or more landmarks at the first point in time with the size and location of the one or more landmarks at a second point in time to determine whether and by how much the size and location of the one or more landmarks has changed,
estimate, based on the change in the size and location of the one or more landmarks, a corresponding change in a location, altitude, or attitude of the UAS from a desired hover pose,
automatically adjust one or more flight controls to compensate for the corresponding change in the location, altitude, or attitude of the UAS, and
continue performing the preceding steps until a size and location of the one or more landmarks substantially matches the size and location of the one or more landmarks at the first point in time.

20. A UAS as set forth in claim 19, wherein the controller is configured to compare the estimated change in location, altitude, or attitude of the UAS from a desired hover pose with telemetry data collected by one or more inertial sensors of the UAV.
